(19) United States
(12) Patent Application Publication
(10) Pub. No.: US 2005/0118309 A1
(43) Pub. Date: Jun. 2, 2005

(54) Snack package adapted for a bottle

(76) Inventor: Mark James Beckman, Seattle, WA (US)

Correspondence Address: John E. Halamka, Esq., P.O. Box 207, Palos Verdes, CA, 90274, US

(21) Appl. No.: 11/044,811

(22) Filed: Dec. 10, 2004

Related U.S. Application Data
(63) Continuation-in-part of application No. 09/301,868, filed on Apr. 29, 1999, now abandoned.

(51) Int. Cl. B67D 5/00

(52) U.S. Cl. 426/120

(57) ABSTRACT

A combination drink bottle, snack package and envelope provides a cylindrical bottle wall joined axially with a diminished diameter bottle neck, which terminates at a removable bottle cap. The sealed snack package contains a snack food adapted for being wrapped around or over the bottle neck for intimate abutnlent therewith. The envelope has a cylindrical envelope wall terminating with an aperture at one end thereof, the aperture adapted for accepting the bottle neck and for positioning an inner surface of the envelope wall intimately against the bottle wall for securement therewith, the envelope further enabled for pressing the snack package against the bottle neck, the envelop wall extending diametrically from the bottle wall no more than by the thickness of the envelope wall.

### BACKGROUND OF THE INVENTION

1. Field of the Invention

This invention relates generally to food packages, and more particularly to such a package adapted for engagement with a standard drink bottle. This application is a continuation in part of application Ser. No. 09/301,868 filed Apr. 29, 1999.

2. Description of Related Art

The following art defines the present state of this field:

C. W. Godefroy, U.S. Pat. No. 2,250,666 describes a combined label and auxiliary container for bottles having necks comprising a perforated portion for fitting over the neck of the bottle, a label portion projecting downwardly from said perforated portion and an auxiliary container secured to said label portion.

G. Clark, U.S. Pat. No. 2,314,607 describes a ticket container for milk bottles comprising an open ended cylindrical body member, a partition intermediately dividing the body member into an upper compartment for reception of tickets or coins, and a lower skirt section for mounting over the upper end of a milk bottle, said skirt section being flared at the lower end or seating on the shoulder of said bottle, a cover hinged to close the ticket compartment and spring means normally holding said cover in closing relation to the compartment.

Patterson et al., U.S. Pat. No. 5,292,028 describes a plate and glass assembly, which include a plate, a beverage container detachably assembled to the plate, and a glass holder which is attached to or formed on the bottom of the plate to hold that component and the glass together. The beverage container may be a commonly available beverage can. Separate caps may be provided for adapting any number of beverage container styles to fit a generic glass holder. A radially extending slot may be provided on the cap through which a straw may be provided to facilitate drinking of the beverage in the container. Nested cans may be provided for additional insulation of the beverage. Indicia on the upper, food-receiving surface of the plate facilitate the assembling of the glass to the plate; and an optional drinking straw port provides a convenient way of locking the plate and glass together and also makes it possible to reach the contents of the glass without removing the plate. The glass holder may comprise rails, which accommodate beverage cans having rims with two or more different diameters.

Franco. U.S. Pat. No. 5,743,423 describes a package comprising a container made of resilient molded plastic that contains an impression and lid. The impression is located in the bottom of the container. The impression comprises two concentric cylindrically shaped tubes, a ring that connects the tubes and a closure. The lower tube has a larger diameter. This lower tube is attached to a ring along the ring's outside edge. The inner edge of the ring is attached to the ring's outside edge. The inner edge of the ring is attached to the upper, smaller-diameter tube. The tubes are identical to the diameters of two sizes of bottle caps. Bottles with caps can then be inserted into the tube. The invention then holds the container on top of the bottle. The lid of the container is removable and re-attachable and forms an airtight seal.

Barnes et al. U.S. Pat. No. 5,674,546 describes a packaged egg omelet mix, which facilitates preparation of omelets by microwave heating. An upper container portion holds an omelet inlay, such as cheese or the like, and has a cylindrical body and an upper end wall. A lower container portion also has a cylindrical body and encloses a sealed container holding an aseptically packaged liquid egg. The omelet is prepared by deposition the liquid egg and omelet inlay into the lower container portion, and placing the lower container portion in a microwave oven for heating.

Nedblake, Jr., U.S. Pat. No. 5,664,671 describes a combination container including a first container containing a beverage and presenting a base, a second container containing an edible solid and presenting an upper surface engaged with the base of the first container, and a band of heat-shrunk material surrounding the containers on either side of the joint there between for coupling the containers into a unitary package. In preferred forms, the heat-shrunk material forms a channel at the joint between the containers to facilitate gripping of the package and the channel is perforated to allow detachment of containers from one another.

Brauner et. al. U.S. Pat. No. 5,318,787 describes a thermoformed bowl filled and sealed with sample food product forms a sample package. The bowl is sized and shaped to the contours of and so as to nest upon the shoulders of a plastic one-gallon jug or bottle. The package has a centrally located die-cut hole to lock under the bottle neck boss. Free samples of the food product can thus be distributed to accompany regular sales of one-gallon plastic containers of milk.

Barton, U.S. Pat. No. 4,635,291 describes a flexible pouch which includes a sealed product-containing pocket, and which pouch also incorporates integral collar-forming structure adapted to enable the pouch to be suspended from an object, such as a bottle neck or the like.

Daviss, U.S. Pat. No. 4,491,220 describes a container for holding popcorn and a drink cup has a box with a band mounted to one box wall beneath a slot. The box may be filled with popcorn and a drink cup held by the band to the box with a cup lip projecting into the slot.

F. M. Bronson et al., U.S. Pat. No. 3,027,037 describes in combination, a bottle and a holder for articles supported thereon, said holder comprising a first frusto-conical shaped member made of a sheet of material, said member being open at its small end and adapted to receive the neck of said bottle with the inside sheet resting on said bottle, and a second frusto-conical shaped member made of sheet like material and having the apex end thereof attached to the base end of said first frusto-conical shaped member.

P. Person, U.S. Pat. No. 2,556,439 describes an attachable container for a milk bottle comprising; a single piece of spring material forked to present a pair of oppositely projecting wings on each side of a central portion; said central portion bent to form the back, bottom and front of a box; two of said oppositely projecting wings bent to form the sides of said box; the other of said oppositely projecting over said hinge; the pin of said hinge projecting there from on one side thereof, bent back on itself to pass over one of said clips and sprung under said lip for resilient door closure pressure there against.

The prior art teaches combination containers for use in combination with liquid and solid foods at the same time. However, the prior art does not teach that a container may be adapted for storing a solid food in such a space that does not appreciable increase either the height or the diameter of a standard bottle of beverage. The present invention fulfills these needs and provides further related advantages as described in the following summary.

### SUMMARY OF THE INVENTION

The present invention teaches certain benefits in construction and use which give rise to the objectives described below.

The present invention provides a combination drink bottle, snack package and envelope, the drink bottle providing a cylindrical bottle wall joined axially with a diminished diameter bottle neck, which terminates at a removable bottle cap. The sealed snack package contains a snack food adapted for being wrapped around or over the bottle neck for intimate abutment therewith. The envelope terminates with an aperture at one end thereof, the aperture adapted for accepting the bottle neck and for positioning an inner surface of the envelope wall intimately against the bottle wall for securement therewith, the envelope is further enabled for pressing the snack package against the bottle neck. The envelope wall extends diametrically from the bottle wall no more than by the thickness of the envelope wall and does not extend the length of the bottle appreciable so that the combination may be used in a standard vending machine.

A primary objective of the present invention is to provide snack envelope combination having advantages not taught by the prior art.

Another objective is to provide such a combination that enable the presentation of a snack with a bottle without taking up more diametrical space than the bottle alone.

A further objective is to provide such a combination that enables the merchandising of a drink and a snack in combination without taking up more height then with the bottle alone.

A still further objective is to provide such a combination that is enabled for use in a standard vending machine without modification of the storage or dispensing apparatus of the machine.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a side elevational exploded view of a first preferred embodiment of the present invention;

FIG. 2 is a side elevational view showing a completed assembly thereof;

FIG. 3 is a sectional view thereof taken along line 3-3 of FIG. 2 showing a first means for sealing;

FIG. 4 is an alternate arrangement of the invention shown in FIGS. 1-3;

FIG. 5 is a sectional view thereof taken along line 5-5 in FIG. 4;

FIG. 6 is similar to FIG. 4 and provides further details thereof;

FIG. 7 is a side elevational view of a further embodiment of the invention; and

FIG. 8 is a sectional view thereof taken along line 8-8 of FIG. 7.

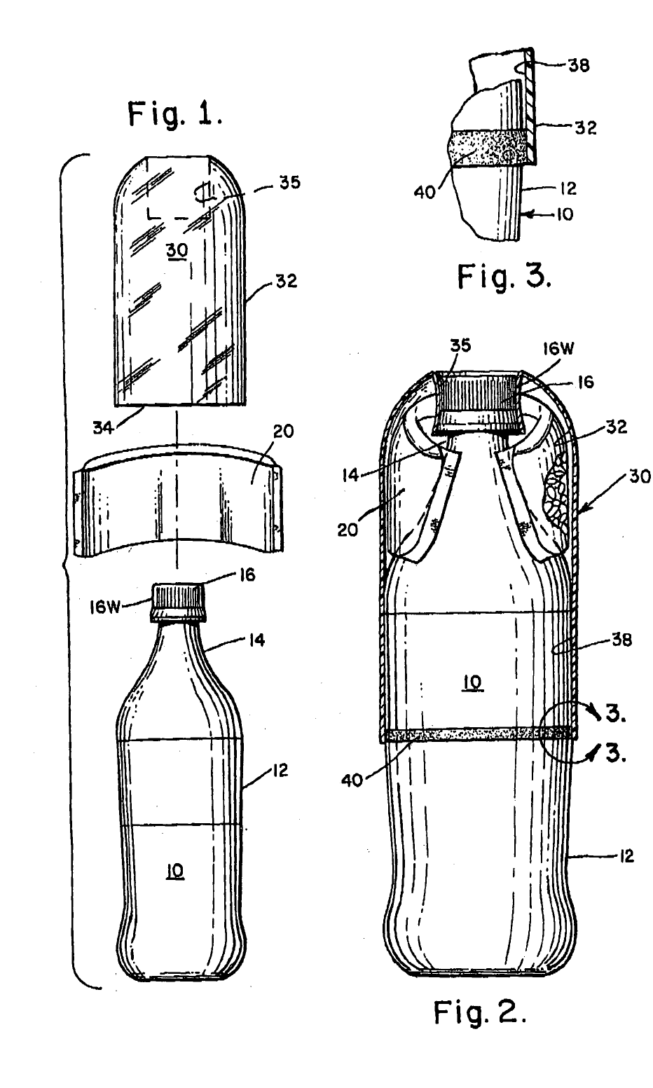

### DETAILED DESCRIPTION OF THE INVENTION

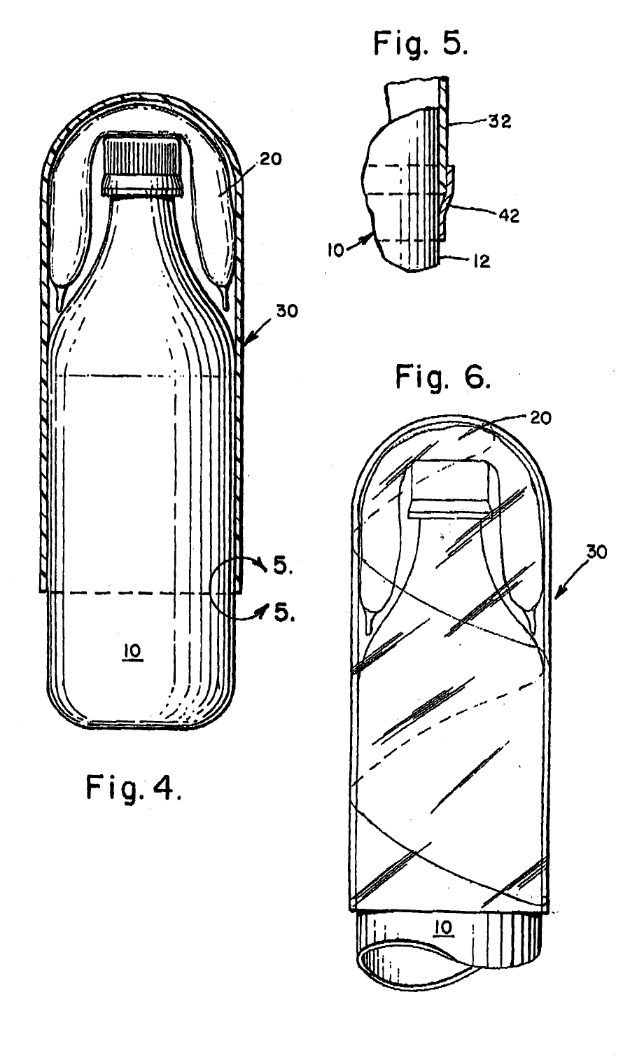

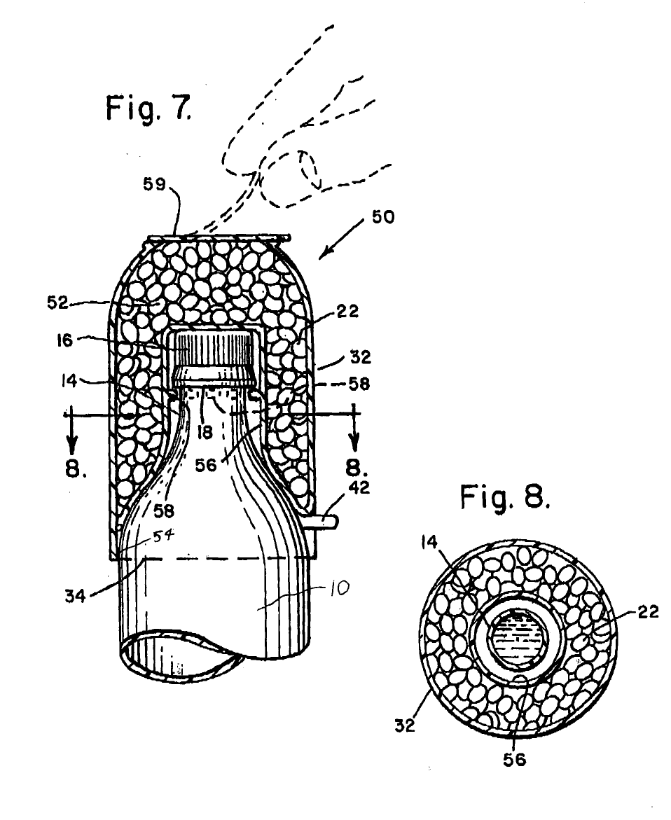

The above described drawing figures illustrate the invention, a combination drink bottle 10, snack package 20 and envelope 30, or the snack package and envelope may be identical; however, first the separate snack package 20 and envelope 30 will be described as follows. The combination comprises a drink bottle 10 providing a cylindrical bottle wall 12 joined axially with a diminished diameter bottle neck 14, the bottle neck terminating at a removable bottle cap 16. The sealed snack package 20, as is commercially available through stores and vending machines contains snacking foods 22, i.e., peanuts, chips, trail mix, etc. The snack package 20 preselected to be of a size and flexibility for being wrapped around, in one embodiment of the invention shown in FIG. 2, and over, in another embodiment shown in FIG. 4, the bottle neck 14 of the drink bottle 10 for intimate abutment therewith so as to not extend beyond the diametrical size of the bottle wall 12 thereby allowing the combination of bottle 10 and snack package 20 to be placed in substantially the same space occupied by just the bottle 10. The envelope 30, preferably of a rigid and transparent molded plastic sheet of a preselected thickness, provides a cylindrical envelope wall 32 terminating with an aperture 34 at one end thereof, is of a diametrical size for accepting the bottle neck 14 in contact with snack package 20 and for positioning an inner surface 38 of the envelope wall 32 intimately against the bottle wall 12 for securement therewith. The envelope 30 further is enabled by its size and shape for pressing the snack package 20 against the bottle neck 14. The envelope wall 32 extends diametrically from the bottle wall 12 no more than by the thickness of the envelope wall 32. This inventively enables the snack envelope 30 to be married to the drink bottle 10 without taking up significant additional space, over that used by the drink bottle 10 alone, in a packing container, on a store shelf, or in a vending machine. Importantly, the present invention is able to be placed wherever a standard bottle alone will fit. Inventively, the envelope further comprises an annular cap sheath 35 extending there within as shown in FIG. 2, the cap sheath 35 having an internal diameter and a selected shape and surface coefficient of friction, for frictional engagement with the exterior side walls 16W of bottle cap 16 for removably securing the envelope 30 tightly to the drink bottle 10. Since it is necessary to exclude vermin from the interior of the envelope 30 a means for sealing same is necessary to the success of the present invention. Such is advantageously accomplished in one of several ways. In one inventive approach, shown in FIG. 3, an adhesive layer 40 is positioned for joining the inner surface of the envelope to the cylindrical bottle wall 12 for sealing the envelope 30. Such an adhesive layer is advantageously of the type of adhesive that may be broken by manual force when removing the envelope 30. In another inventive approach, shown in FIG. 5, an adhesive strip 42 is positioned for joining the envelope wall 14 to the cylindrical bottle wall 32 for sealing the envelope 30. Such an adhesive strip 42, such as a tape, may be bonded in place as is shown in FIG. 5, or it may be integral with the envelope wall 32 and scored for peel removal as shown in FIG. 7. In a further inventive approach, shown in FIG. 6, the envelope wall 32 is spirally scored 39 so as to enable peeling the envelope 32 away from the drink bottle 10 and preferably to enable this a starting tap 39T is provided (FIG. 6).

Now referring to FIGS. 7 and 5, there is depicted the referenced alternate embodiment of the present invention, a combination drink bottle 10 and snack package envelope 50, which envelope 50 is a joining together of the snack package 20 and the envelope 30 as described above, comprises the drink bottle 10 providing the cylindrical bottle wall 12 joined axially with the diminished diameter bottle neck 14. The bottle neck 14 terminates at the removable bottle cap 16 as previously described. The sealed snack envelope 50 is fabricated in a preselected shape thereby providing a cavity 52 for receiving the snack food 22, the snack envelope 50 having the cylindrical envelope outer wall 32 of a preselected size so as to not extend beyond the diametrical size of the bottle wall 12 more than the thickness of wall 32 of the envelope 50 terminating with the aperture 34 at one end thereof, the aperture 34 adapted for accepting the bottle neck 14 and for positioning an inner surface 54 of the envelope intimately against the bottle wall 12 for securement therewith, the sealed snack envelope 50 further providing a concentrically oriented cylindrical inner wall 56 enabled for engagement over the bottle neck 14, the snack envelope 50 extending diametrically from the bottle wall 12 no more than by the thickness of the outer envelope wall 32. The inner wall 56 is fabricated for engagement with the bottle neck 14 is inventively, an inwardly radially directed protuberance 58 for snap removably catching under a neck ridge 18 of the bottle 10. This ridge 18 is an element on most commercial bottles and provides rigidity to the neck 14 where the cap 16 is attached. Such a protuberance 58 may be an annular ridge, a plurality of bosses arranged annularly or other manifestation for catching on the neck ridge 18.

As shown in FIGS. 7 and 8, the snack envelope 50 inventively has an access means 59, such as a peel to open scored portion of the top of the envelope, and is preferably positioned in opposition to the bottle cap 16 so as to enable access to the snack food 22 within the envelope 50 before or after the snack envelope 50 is removed from snap engagement with the bottle 10.

While the invention has been described with reference to at least one preferred embodiment, it is to be clearly understood by those skilled in the art that the invention is not limited thereto. Rather, the scope of the invention is to be interpreted only in conjunction with the appended claims.

1. A combination drink bottle, snack package and envelope, the combination comprising:
a drink bottle providing a cylindrical bottle wall joined axially with a diminished diameter bottle neck, the bottle neck terminating at a removable bottle cap;
a sealed snack package containing a snack food, the snack package adapted for being wrapped around the bottle neck of the drink bottle for intimate abutment therewith; and
an envelope having a cylindrical envelope wall terminating with an aperture at one end thereof, the aperture adapted for accepting the bottle neck and for positioning an inner surface of the envelope wall intimately against the bottle wall for securement therewith, the envelope further enabled for pressing the snack package against the bottle neck, the envelope wall extending diametrically from the bottle wall no more than by the thickness of the envelope wall.

2. The combination of claim 1 wherein the envelope further comprises an annular cap sheath extending there within, the cap sheath adapted for frictional engagement with the bottle cap for securing the envelope to the drink bottle.

3. The combination of claim 1 further providing an adhesive layer positioned for joining the inner surface of the envelope to the cylindrical bottle wall for sealing the envelope.

4. The combination of claim 1 further providing an adhesive strip positioned for joining the envelope wall to the cylindrical bottle wall for scaling the envelope.

5. The combination of claim 1 wherein the envelope wall is spirally scored so as to enable peeling the envelope away from the drink bottle.

6. A combination drink bottle, snack package and envelope, the combination comprising:
a drink bottle providing a cylindrical bottle wall joined axially with a diminished diameter bottle neck, the bottle neck terminating at a removable bottle cap;
a sealed snack package containing a snack food, the snack package adapted for being wrapped over the bottle neck of the drink bottle for intimate abutment therewith; and
an envelope having a cylindrical envelope wall terminating with an aperture at one end thereof, the aperture adapted for accepting the bottle neck and for positioning an inner surface of the envelope wall intimately against the bottle wall for securement therewith, the envelope further enabled for pressing the snack package against the bottle neck, the envelope wall extending diametrically from the bottle wall no more than by the thickness of the envelope wall.

7. The combination of claim 6 further providing an adhesive layer positioned for joining the inner surface of the envelope to the cylindrical bottle wall for sealing the envelope.

8. The combination of claim 6 further providing an adhesive strip positioned for joining the envelope wall to the cylindrical bottle wall for sealing the envelope.

9. The combination of claim 6 wherein the envelope wall is spirally scored so as to enable peeling said envelope away from the drink bottle.

10. A combination drink bottle and snack package, the combination comprising:
a drink bottle providing a cylindrical bottle wall joined axially with a diminished diameter bottle neck, the bottle neck terminating at a removable bottle cap; and
a snack package fabricated as an envelope having an inner wall and an outer wall having a sealable opening mounted on said outer wall fro removabely receiving a snack food, the snack package envelope having a cylindrical envelop outer wall joined to said inner wall, terminating with an aperture at one end thereof, the aperture having a size and shape for accepting the bottle neck and removable cap and located so that under the condition of said aperture engaged with said bottle neck and cap, there is a wall intimately against the bottle wall for securement therewith, the aperture further providing a concentrically oriented cylindrical inner wall for engagement with the bottle cap, the snack envelope extending diametrically from the bottle wall no more than by the thickness of the outer envelope wall thereby allowing said combination to occupy substantially he same space as a drink bottle alone.

11. The combination of claim 10 further providing an adhesive layer positioned for removable joining the inner surface of the snack envelope to the cylindrical bottle wall.

12. The combination of claim 10 further providing an adhesive strip positioned for joining the snack envelope wall to the cylindrical bottle wall for sealing the opening of said aperture.

13. The combination of claim 10 wherein the outer snack envelope wall is spirally scored so as to enable pealing the envelope without releasing said snack food from said envelope, thereby allowing a user to remove said snack envelope away from the drink bottle

14. The combination of claim 10 further comprising a catch mounted on the inner wall for engagement with the bottle neck, said catch fabricated in the form of an inwardly radially directed protuberance.

15. The combination of claim 14 wherein the protuberance is an annular ridge.

16. The combination of claim 14 wherein the protuberance is a plurality of bosses.

17. The combination of claim 14 wherein the envelope has an access means positioned in opposition to the bottle cap so as to enable access to a snack food within the envelope.
